(19) United States
(12) Patent Application Publication
(10) Pub. No.: US 2012/0045155 A1
(43) Pub. Date: Feb. 23, 2012

(54) SEALED HUB-BEARING ASSEMBLY FOR AGRICULTURAL APPLICATIONS

(75) Inventors: Luca Morero, Pinerolo (TO) (IT); Fabio Picatto, Torino (IT); Ove Lennart Andersson, Alingsas (IT); Stephano Urso, Torino (IT); Massimo Marivo, Airasca (TO) (IT); Carlo Maldera, Giaveno (TO) (IT); Marco Panchetti, Torino (TO) (IT); Andea Magnetto, Torino (IT)

(73) Assignee: AKTIEBOLAGET SKF, Göteborg (SE)

(21) Appl. No.: 13/266,400

(22) PCT Filed: Apr. 29, 2009
(86) PCT No.: PCT/EP2009/055203

§ 371 Date: Oct. 26, 2011

(51) Int. Cl. F16C 33/76; F16C 33/80; F16C 33/78

(52) U.S. Cl. 384/480; 384/477; 384/485

(57) ABSTRACT

A sealed hub-bearing assembly for agricultural applications includes a hub-bearing unit 10 with a flanged outer ring 11 and a pair of radially inner stationary rings 16, 17 tightly mounted side to side. A sealing device 20 is mounted on a side of the hub-bearing unit 10 opposite to the side of the flange 12 and includes a sealing gasket 32 which is arranged to slide against the outer ring 11 and it is mounted by snap-action in a circumferential groove 18 formed in the inner ring 17 located farthest from the side of the flange 12.

The present invention refers to a sealed hub-bearing assembly for agricultural applications.

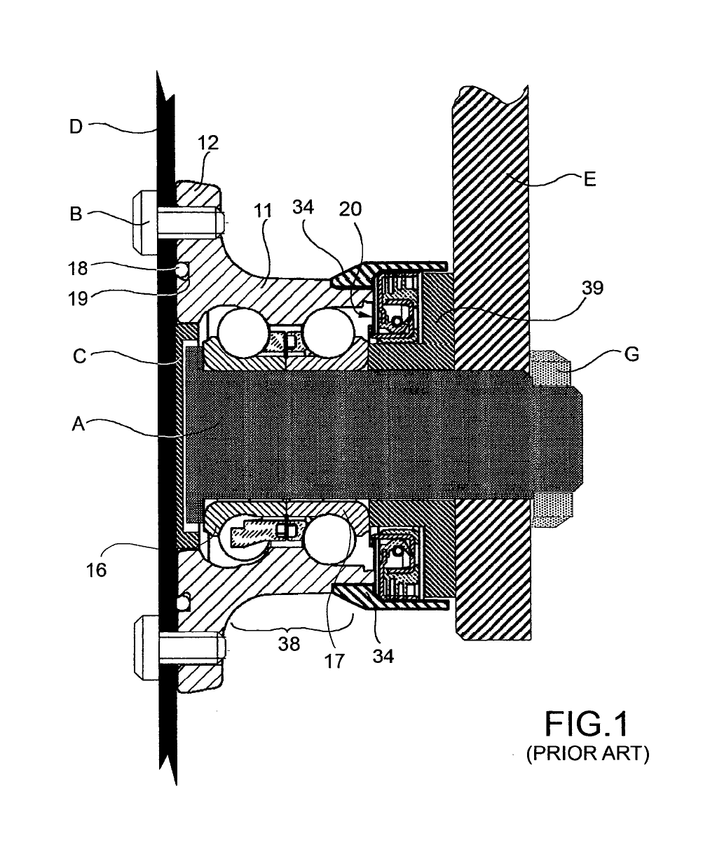

For a better understanding of the state of the art and problems related thereto, there will be at first described a hub-bearing assembly for agricultural applications known from WO 2007/105185, shown in FIG. 1 of the appended drawings. The known hub-bearing unit comprise a radially outer, rotatable outer ring 11 from one side of which a flange 12 radially extends and pair of identical, symmetrically arranged inner bearing rings 16, 17 are tightly mounted side to side on the axle A projecting from an arm E of the frame of an agricultural machine. In order to prevent contaminants (water, mud, soil) from entering the bearing from the side near the arm of the frame, the bearing unit is equipped with a sealing device 20. The sealing device is fitted between an outer collar 34 secured to the outer ring 11 and an inner L-shaped side shield 39 which is fitted around the axle A and axially clamped against the frame E.

It is an object of the invention to provide an arrangement for mounting the sealing device to the bearing unit, thereby allowing them to be handled and shipped together as a single piece. Furthermore, it is desirable to allow a component to be dispensed with, while not increasing the axial size of the inner bearing rings. Particularly, the axial dimension of the inner bearing rings must not be increased. These rings must be identical for manufacturing reasons, symmetrical in order to assure proper balancing of the bearing.

It is also desirable to improve the effectiveness of the sealing device, particularly by preventing water from leaking into the bearing along a path which, in the conventional design of FIG. 1, is defined between the frame arm E, the axle A and the side shield 39. Efficient sealing action is essential for a correct and reliable operation of the disc over an acceptable period of time. Since the contamination conditions are extreme, contaminants entering the inner parts of the bearing will rapidly cause the disc to lock, reducing productivity of the agricultural machine.

The present invention is directed at providing such improvements over existing bearing designs for agricultural applications. The above and other objects and advantages, which will be better understood in the following, are achieved according to the invention by a hub-bearing assembly having the features defined in claim 1. Preferred embodiments of the invention are set forth in the dependent claims.

Preferred, but not limiting embodiments of the invention will now be described, reference being made to the appended drawings, in which:

FIG. 1 is an axial cross-sectional view of a hub-bearing assembly of known design, which rotatably supports a soil working disc on an axle projecting from an arm of an agricultural machine;

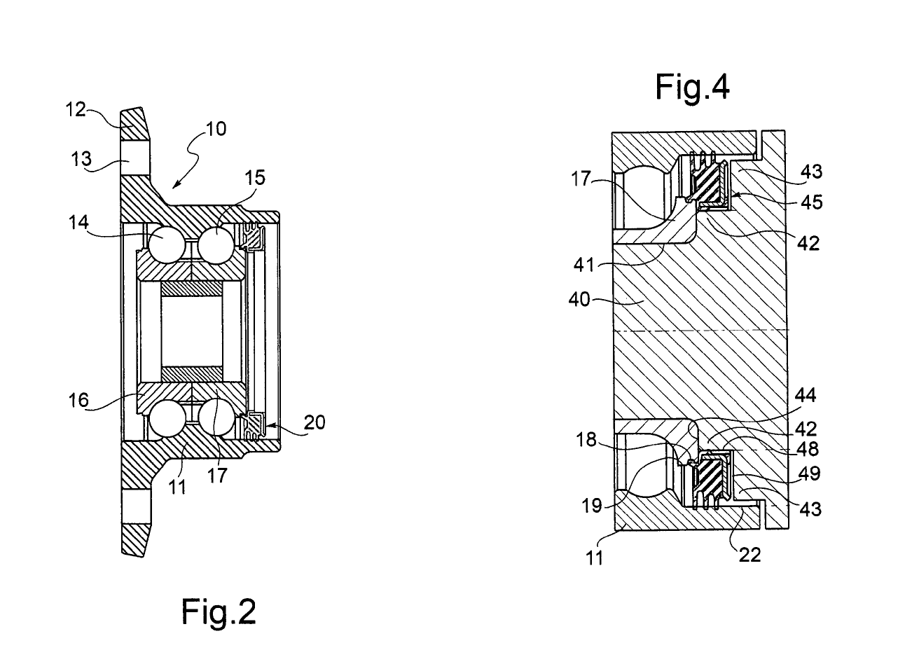

FIG. 2 is an axial cross-sectional view of an illustrative embodiment of a sealed hub-bearing assembly according to the invention;

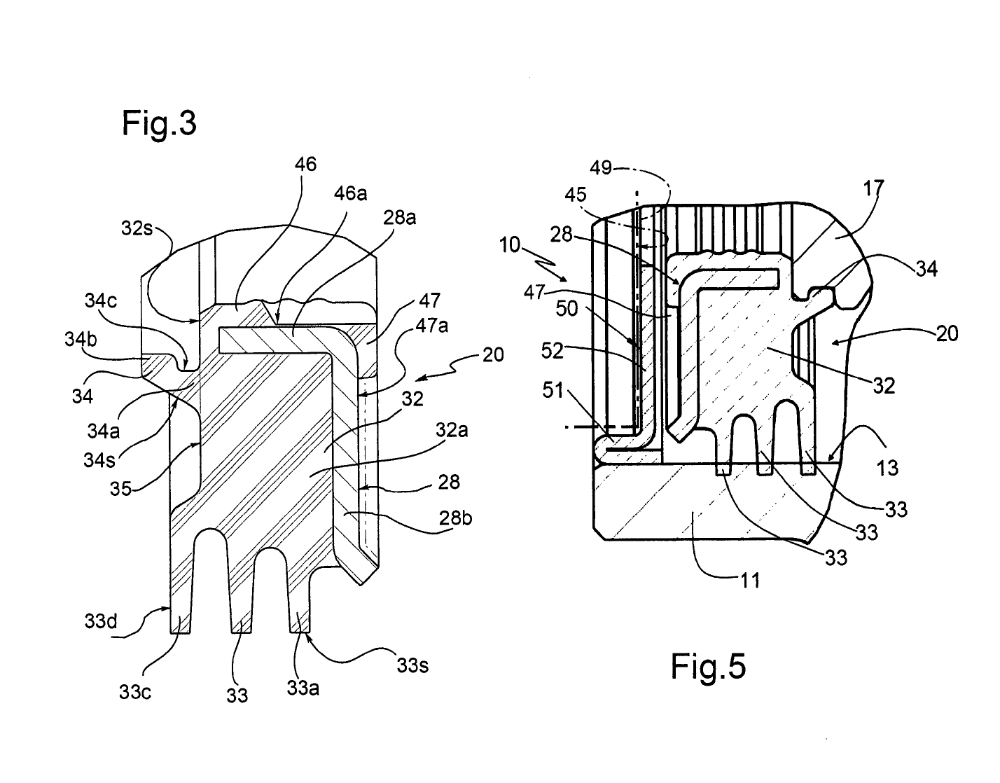

FIG. 3 is a fragmentary, enlarged view of a detail of FIG. 2;

FIG. 4 is a partial, axial cross sectional view of the sealed hub-bearing assembly of FIG. 1 mounted on an agricultural axle; and

FIG. 5 is an enlarged view, with some parts removed for reasons of clarity, of an optional element of the sealed hub-bearing assembly of FIG. 2.

In the text below, the structure of the hub-bearing assembly will be described only to such an extent as is necessary for the understanding of the invention. Referring now to FIG. 2, a sealed hub-bearing assembly for agricultural applications comprises a hub-bearing unit, indicated overall at 10, and an associated sealing device 20.

The hub-bearing unit 10 comprises:
a rotatable outer ring 11 forming on one side a radial flange 12 on the opposite side a cylindrical seat 13;
a pair of inner stationary rings 16, 17 which are able to be tightly mounted side to side on a central axle 40, partly shown in FIG. 4, projecting from the frame (not shown) of an agricultural machine; and
a dual set of bearing balls 14, 15 which are interposed between the outer ring 11 and the stationary rings 16, 17.

The sealing device 20 is fitted within the seat 13. As shown more clearly in FIG. 4, it is attached to one of the inner bearing rings 17, namely the inner ring fitted towards the proximal part of the axle 40. In this context, the term “proximal” denotes an axially inner location that in use will be near the supporting arm of the frame, whereas “distal” indicates an axially outer location towards that end of the axle which is near the tilling disc.

The axle 40 is formed with a cylindrical portion 41 on which the inner bearing rings 16, 17 are inserted, and two annular steps 42, 43. The first annular step 42, of smaller diameter, defines a radial shoulder 44 against which the inner bearing rings are axially clamped. The second annular step, of larger diameter, defines an annular seat 45 for the sealing device 20.

The sealing device 20 includes a resilient annular gasket 32 of elastomeric or rubber-like material, and an annular metal stiffening insert 28 which has a substantially L-shaped axial cross section and supports the gasket 32. The insert 28 has a cylindrical portion 28a which is coaxial to an axis x of rotation of the hub-bearing unit 10 and a flanged portion 28b which is integral with the portion 28a and is perpendicular to the axis x from which it extends towards the periphery of the sealing device 20.

The gasket 32 is provided with an annular bulge or protrusion 34 and with a set of parallel, radially outwardly extending lips 33 (three in the illustrated example) that are arranged to slide against the inner cylindrical wall 22 of the outer bearing ring 11, thereby sealingly bridging the annular space between the inner ring 17 and the outer ring 11. All the lips 33 are outer radially bounded by a common cylindrical surface 33s in sliding contact with the seat 13, and have three different radial lengths: the shortest lip 33a is placed nearby the portion 28b and the longest lip 33c is placed axially far from the portion 28b and is provided with a flat annular surface 33d substantially parallel to the portion 28b. It should be noted that in the appended drawings the gasket 32 is depicted in its non-deformed condition.

As best seen in FIGS. 3 and 4, the gasket 32 comprises a body 32a which is axially delimited by a surface 32s and is integrally coupled with the insert 28. The surface 32s is parallel to the portion 28b and faces the hub-bearing unit 10 in its assembled position. The protrusion 34 extends in a somewhat conical direction from the surface 32s and comprises a root portion 34a which is tapered starting form the surface 32s and a distal finger 34b which forms with the surface 32s an annular undercut 34c. The root portion 34a and the distal finger 34b are both bounded by an external conical surface 34s which joins the surface 32s and defines together with the surface 32s and the surface 33d an annular cavity 35 the function of which is also to keep the lubricating grease within the hub-bearing unit 10.

The protrusion 34 extends from the axially outer and radially inner part of the body 32a and is close to the portion 28a so that it can exploit the stiffness that the portion 28a gives the body 32a in that area in order to ensure a stable connection with the inner ring 17.

The protrusion 34 is snap-fitted into the circumferential groove 18 in order to mount the sealing device 20 onto the hub-bearing unit 10 and in order to make the surface 32s to be adherent to the side surface of the inner ring 17 and to allow the inner ring 17 to be inserted in the undercut 34c.

The sealing device 20 furthermore comprises resilient coating portions 46 and 47 which are coupled respectively with the portion 28a and the portion 28b to be pressed against the cylindrical 48 and, in some circumstances, also against the radial 49 sides of the annular seat 45.

The coating portions 46 and 47 are provided with a number of slots 46a and 47b to improve elasticity of the same coating portions 46 and 47 and continuously surround the axle 40, providing static sealing action around the axle and interrupting any leakage path towards the inner parts of the bearing unit. The slots 46a are circumferentially spaced from each other and are parallel to the axis x, while the slots 47a are perpendicular to the axis x and are also separated by the relevant slots 46a.

FIG. 5 shows a preferred embodiment of the sealed hub-bearing unit 10 wherein the sealing device 20 further includes an annular disc 50 which is preferably made of sheet steel and is placed axially in front of but not in contact with the annular gasket 32 in order to define a labyrinth seal.

The disc 50 comprises a fixing portion 51 which is defined by a folded annular metal sheet and it is suitable to be mounted in the seat 13, and a flange 52, which is integral with the fixing portion 51 facing the coating portion 47 and which has an inner diameter the dimensions of which are greater than the dimensions of an inner diameter of the coating portion 46. The steel labyrinth 50 has a double function: firstly, it improves the overall sealing performance of the sealing device 20 by providing an additional labyrinth sealing action; secondly, it keeps the annular gasket 32 in its operative configuration while the sealed hub-bearing unit 10 ahs to be dismounted from the axle 40. The fixing portion 51 is suitable to occupy the gap between the cylindrical wall 22 and the annular step 43, and the flange 52 is suitable to occupy the gap between the coating portion 47 and radial 49 sides of the annular seat 45 without being in touch neither with the former nor the latter.

It will be appreciated that, by virtue of the above arrangement, the sealing device may be handled with the bearing unit. The axial size of the bearing assembly is kept very compact. Particularly, the inner rings need not be extended in order to provide a supporting surface for the sealing device. A conventional component, the side shield 39, is dispensed with. Improved, watertight sealing action is provided between the bearing unit and its supporting axle.

1. A sealed hub-bearing assembly for agricultural applications, the assembly comprising:
a hub-bearing unit with a radially outer, rotatable outer ring that extends radially from a first side of a flange, and
a pair of radially inner stationary rings tightly mounted side to side;
a sealing device mounted on a side of the hub-bearing unit opposite to the first side of the flange, and wherein
the sealing device including a stationary resilient annular sealing gasket arranged to slide against an inner cylindrical wall rotating with the outer bearing ring, thereby sealingly bridging the annular space between the inner and outer bearing rings; and wherein
the resilient gasket is mounted to the radially inner ring located farthest from the first side of the flange and comprises an annular protrusion mounted by snap-action in a circumferential groove formed in the inner bearing ring.

2. The sealed hub-bearing assembly of claim 1, wherein the groove is formed in a radially outer surface of the inner bearing ring.

3. The sealed hub-bearing assembly of claim 1, wherein the protrusion is an annular bulge.

4. The sealed hub-bearing assembly of claim 1, wherein the protrusion extends in a conical direction from an axially outer and radially inner part of the gasket.

5. The sealed hub-bearing assembly of claim 1, wherein the gasket further comprises:
at least one radially outwardly extending lip arranged to slide against said inner cylindrical wall, and
at least one resilient portion formed on at least one of a radially inner side and an axially outer side of the gasket.

6. A sealed hub-bearing assembly as claimed in claim 5, further comprising three radially outwardly extending lips which are radially bounded on the outside by a common cylindrical surface in sliding contact with said inner cylindrical wall, and which have three different radial lengths.

7. A sealed hub-bearing assembly as claimed in claim 1, wherein the sealing device further comprises a labyrinth seal which is axially placed in front of the annular gasket and which is mounted in the inner cylindrical wall.

8. A sealed hub-bearing assembly as claimed in claim 7, wherein the labyrinth seal further comprises:
a folded fixing element mounted in the inner cylindrical wall, and
a flange, which is integral with the fixing element and faces the annular gasket.
